(19) United States
(12) Patent Application Publication
(10) Pub. No.: US 2016/0302548 A1
(43) Pub. Date: Oct. 20, 2016

(54) DRYER

(71) Applicant: YA-MAN LTD., Tokyo (JP)

(72) Inventor: Iwao YAMAZAKI, Tokyo (JP)

(21) Appl. No.: 15/101,216

(22) PCT Filed: Nov. 28, 2014
(86) PCT No.: PCT/JP2014/081513

§ 371 Date: Jun. 2, 2016

(30) Foreign Application Priority Data
Dec. 3, 2013 (JP) 2013-250448
Mar. 27, 2014 (JP) 2014-065437

(51) Int. Cl. A45D 20/12; A61H 23/02

(52) U.S. Cl. CPC A45D 20/12; A61H 23/02; A61H 2201/0153; A61H 2201/0207; A61H 2201/025; A61H 2201/0107; A61H 2205/021; A61H 2201/5025

(57) ABSTRACT

To provide a dryer that can simply and effectively massage the scalp. The main body of this dryer, which dries the scalp and provides vibratory stimulation to the scalp, is provided with a blower which sucks air from the outside and blows the air towards a blower port, a heater and/or a heater which heats the blown air, a scalp massage attachment which is attached in the blowing direction of the blower port, and a vibrator which generates vibration to vibrate the scalp massage attachment.

### TECHNICAL FIELD

The invention relates to a dryer to dry the scalp and hair, specifically a dryer including a vibration function and a thermal function.

### BACKGROUND ART

Conventionally, dryers configured to radiate infrared rays so as to dry the scalp and hair from the inside have been proposed. For example, the hair dryer of Patent Literature 1 includes one of a roll brush, a brow brush, a curler and a comb, to which ceramic material for radiating far infrared rays is arranged. According to Patent Literature 1, the ceramic material heated by hot air provides far infrared rays to hair. Patent Literature 2 discloses similar contents.

Patent Literature 3 discloses the invention relating to a hair curler configured to radiate far infrared rays by a punching bobbin that is a metal cylinder coated with ceramic on the surface thereof for rolling hair round. According to the configuration of Patent Literature 3, the hot air blown by a dryer can easily form curls by rolling hair round the punching bobbin because warm air of the dryer can warm the hair from the core of the punching bobbin.

A dryer with a scalp massaging function has been proposed. The blowing nozzle for hair dryer disclosed in Patent Literature 4 can, while providing various treatments such as disentangling hair, raising the root of the hair and straightening the hair flow, apply the air blown by the dryer to the part to which such treatments take effect, and thus can give a scalp massaging effect. To achieve such a function, the dryer includes a nozzle body that is detachably connected to a blower port of the hair dryer and has a nozzle passage from a nozzle inflow port to a nozzle outflow port, and a plurality of pin bodies that are arranged protruded along a blowing direction from the nozzle outflow port so that each tip of the pin bodies can contact with the scalp.

In the invention disclosed in Patent Literature 5, the dryer can provide scalp massaging or spot-stimulating while blowing air as a measure to prevent hair loss. In accordance to Patent Literature 5, with the arrangement of a rotatable wheel with warty protrusions on the nozzle edge of the dryer, a user can obtain massaging and spot-stimulating by moving the dryer while applying hot air. The warty protrusions contacting with the scalp are arranged away from the outflow port of the dryer by 10 centimeters or longer to prevent the scalp from being damaged by the hot air.

### CITATION LIST

### Patent Literature

Patent Literature 1: Japanese utility model of Publication No. 62-143409

Patent Literature 2: Japanese utility model of Publication No. 63-30902

Patent Literature 3: Patent publication No. 2008-264153

Patent Literature 4: Japanese utility model of registration No. 3184955

Patent Literature 5: Patent publication No. 2008-148848

### SUMMARY OF INVENTION

### Technical Problem

According to the conventional technologies described above, a brush itself is applied with ceramic material, and configured to radiate infrared rays when hot air from the dryer is applied. However, there is a problem that the radiated infrared rays are not sufficient. There is another problem that with another proposed configuration of a dryer with pin bodies or with a wheel having warty protrusions, a user has to move the dryer widely by the hand and a massage effect is not sufficient.

The purpose of the invention is to provide a dryer that can simply and effectively massage the scalp while taking into consideration the problems in conventional technologies.

### Solution to Problem

To solve the problems described above, the invention provides a dryer described below.

According to Claim 1, the invention can provide a dryer that performs drying and a vibratory stimulation to the scalp, including in a dryer body a blower that sucks air from outside and blows the air towards a blower port, a heater that heats the blown air, a scalp massage attachment that is attached along a blowing direction of the blower port, and a vibrator that generates vibration to vibrate the scalp massage attachment.

According to the invention described in Claim 2, the above dryer may include at least an infrared ray heater as the heater of the dryer body to radiate infrared rays to the scalp and hair through the blower port.

According to the invention described in Claim 3, an auxiliary handle part for pressing the scalp massage attachment towards the scalp may be attached in a back side of the scalp massage attachment of the above dryer body.

According to the invention described in Claim 4, the dryer may include as the heater of the dryer body, a ceramic heater that has output power of 400 W or less to mainly radiate infrared rays, and a nichrome wire heater that has output power of 1200 W or less to mainly heat air, wherein the ceramic heater is only used so as to perform the vibratory stimulation by the scalp massage attachment, while at least one of the ceramic heater and the nichrome wire heater is used so as to perform the drying.

According to the invention described in Claim 5, the above dryer body includes a cylindrical part and a handle part that is extended downward from a cylindrical side face of the cylindrical part, where in the cylindrical part from an edge part, the scalp massage attachment, the blower port, the ceramic heater, the nichrome wire heater and the blower are arranged in order, and further having a vibration transmission part that uses a vibration motor as the vibrator and connects the scalp massage attachment and the vibration motor. In the configuration, a user uses the dryer with the blower port facing the body by grasping the handle part.

According to the invention described in Claim 6, the above auxiliary handle part may be extended from the above cylindrical side face of the cylindrical part in at least one of a left side, a right side and on an upper part, and have a pressing face part parallel to a radial cross section of the cylindrical part.

According to the invention described in Claim 7, by use of an electric resistance of a nichrome wire used for the nichrome wire heater, at least one of the above blower and the ceramic heater may be controlled.

According to the invention described in Claim 8, the scalp massage attachment may be detachable in a vicinity of the blower port.

According to Claim 9, the invention can provide a vibration attachment that is mounted to a dryer body. The vibration attachment includes a mounting part that is mounted to a blower port of the dryer body, a scalp massage attachment that is attached along a blowing direction of the blower port, and a vibrator that generates vibration to vibrate the scalp massage attachment.

### Advantageous Effects of Invention

The configuration described above according to the invention can provide the following effects.

That is, the arrangement of the scalp massage attachment that can vibrate allows the dryer to perform a vibratory stimulation to the scalp, as well as drying scalp. Specifically, a user does not have to move the blower port of the dryer widely unlike a conventional dryer, and can obtain massaging only by making the dryer contact with the scalp.

The arrangement of the infrared wire heater provides a thermal effect during drying and a vibratory stimulation. The configuration can drastically enhance radiation efficiency of infrared rays, compared to the configuration according to conventional technologies in which a brush is heated by hot air and the ceramic material arranged on the brush indirectly radiates infrared rays. In addition, the configuration can provide the dryer that dries the scalp and hair inside while reducing thermal damage to the scalp and hair due to the temperature of the dryer set lower (ex. 50 degrees or less) than a temperature of a normal dryer when the infrared ray heater is on.

The arrangement of the auxiliary handle part to the dryer of the invention facilitates the adjustment of a direction and power for making the scalp massage attachment contact with the scalp, and thus a user can appropriately press the scalp massage attachment.

Further, the arrangement of the pressing face part parallel to a radial cross section of the cylindrical part of the auxiliary handle allows a user easily to hold the pressing face part by hand, resulting in providing comfort in use.

The arrangement, as a heater of the dryer body, of the ceramic heater that has output power of 400 W or less to mainly radiate infrared rays, and the nichrome wire heater that has output power of 1200 W or less to mainly heat air allows heating according to usage. Heating temperature is suitably adjustable, and thus, drying and massaging can be performed while minimizing thermal damage.

The invention is applicable to a shape of a normal dryer including a cylindrical part and a handle part that is extended downward from a side face of the cylindrical part. Therefore, a dryer even in a shape hardly moved by hand can easily provide a vibratory stimulation and a thermal effect to the scalp. In addition, the invention can provide a dryer with various functions in a size similar to a conventional dryer.

The use of an electric resistance of a nichrome wire for the nichrome wire heater allows various kind of controlling with respect to at least one of the blower and the ceramic heater, and further contributes the reduction of the number of components and energy saving.

The invention can provide only a vibration attachment detachable from a dryer.

### BRIEF DESCRIPTION OF DRAWINGS

FIG. 1 shows a disassembled oblique view of a dryer of the invention.

FIG. 2 shows a front view of the dryer of the invention.

FIG. 3 shows a sectional-right-side view cut along A-A line of the front view.

FIG. 4 shows a back view of the dryer of the invention.

FIG. 5 shows a block diagram illustrating controlling of the dryer of the invention.

FIG. 6 shows the first example of an auxiliary handle part of the dryer of the invention.

FIG. 7 shows the second example of the auxiliary handle part of the dryer of the invention.

### DESCRIPTION OF EMBODIMENTS

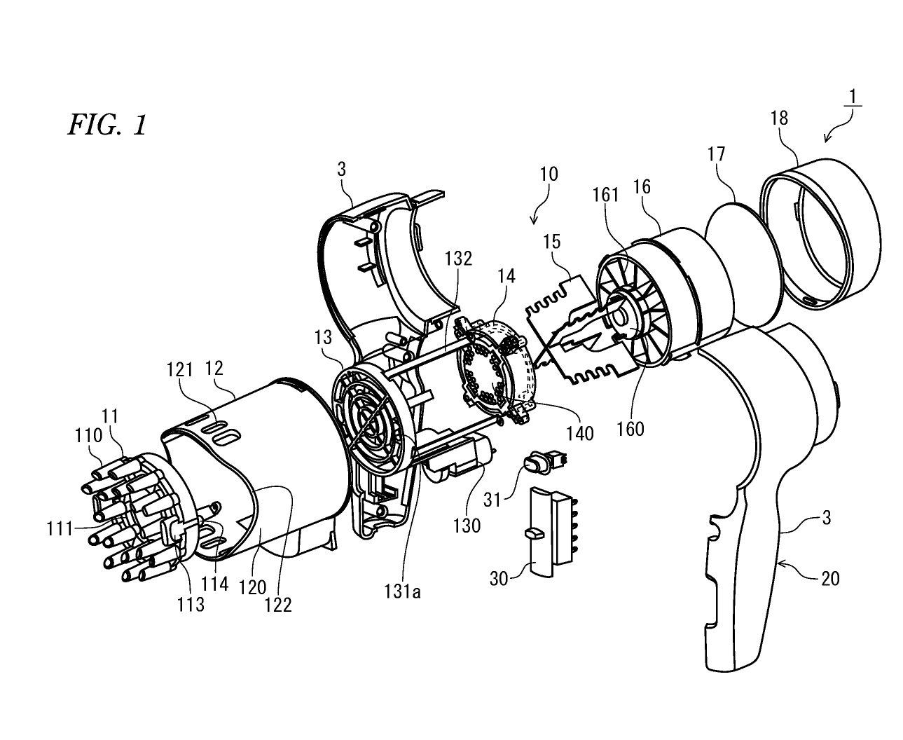

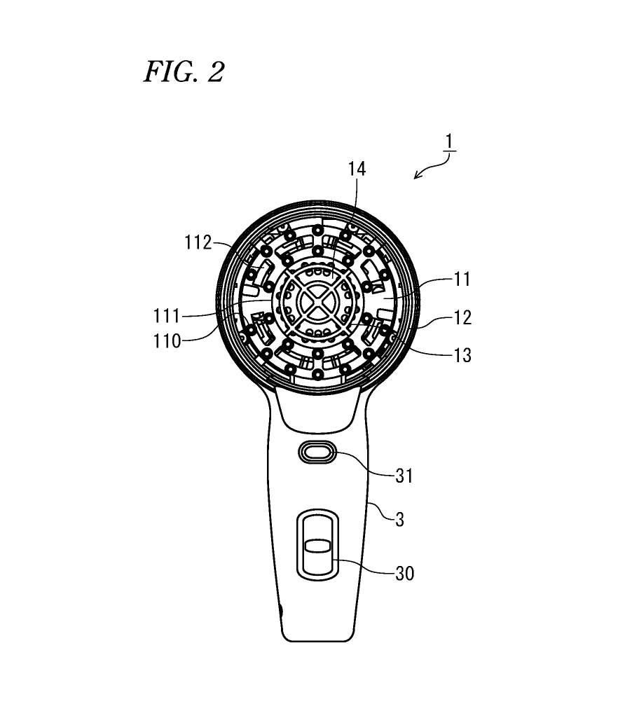

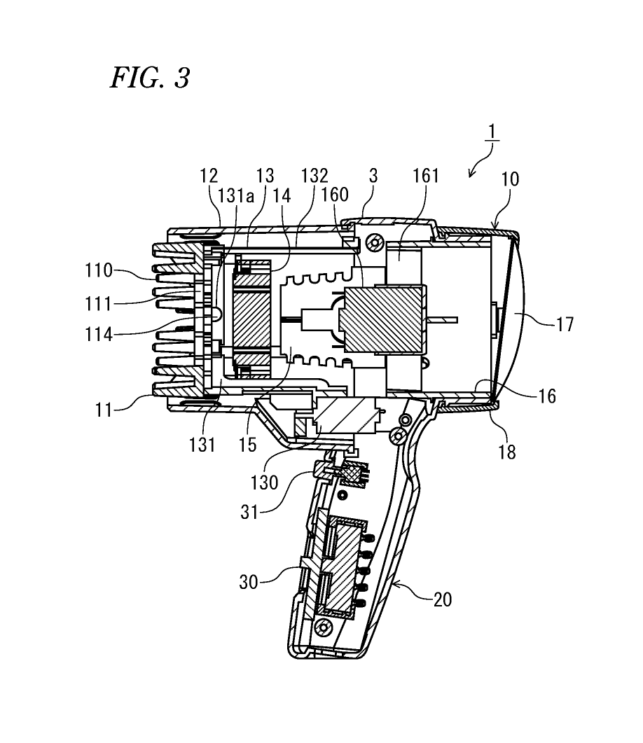

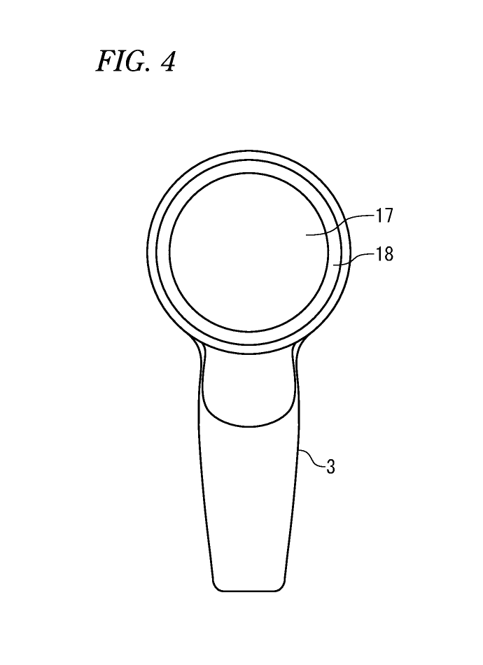

FIG. 1 shows a disassembled oblique view of a dryer of the invention. FIG. 2, FIG. 3 and FIG. 4 respectively show a front view, a sectional-right-side view cut along A-A line of the front view, and a back view.

The dryer of the example has an appearance similar to a general hand-held dryer. A user can use the dryer having a familiar shape for drying hair, and also can store the dryer in a predetermined place. In addition to the above, the invention provides a dryer with a thermal effect and a vibration function by use of an infrared ray heater or the like.

The shape of the dryer can arbitrarily be changed within the scope stated in the claims, not limited to the example.

A dryer body 1 includes a cylindrical part 10 that has a cylindrical shape from the front side towards the back side of the cylindrical part 10 in its appearance and a handle part 20 that is extended downward from the bottom face of the cylindrical part 10. The cylindrical part 10 incorporates blowing, thermal and vibration functions of the invention, while the handle part 20 includes switches for operating these functions of the dryer and a grip for holding the dryer body 1. A power cord connected to the bottom end of the handle part 20, not shown in the figure, supplies power. The dryer may be a cordless dryer having a battery inside.

The cylindrical part 10 includes, from its edge (scalp side) in order; a scalp massage attachment 11, a blower port case 12, a vibrator 13, a ceramic heater 14, a nichrome wire heater 15, a blower fan 16, a filter 17 and an air supply port case 18, all which are held in a housing 3 integrally formed with the handle part 20 at the middle part of the full length of the housing 3.

The scalp massage attachment 11 of the invention can be used as a general brush, as well as being used for scalp massaging. Further, the scalp massage attachment 11 is detachably replaceable in accordance with usage. For example, a metal attachment and a resin attachment can be provided.

The scalp massage attachment 11 has a number of protrusions 110 protruded towards a blowing direction as shown in the figure. The scalp massage attachment 11 has in the center thereof an opening of a central blowing hole 111 for blowing heated air, and also is configured so that infrared rays are radiated directly from a heater surface 140 of the ceramic heater 14 through the central blowing hole 111 while blowing, as shown in the front view.

In addition, the scalp massage attachment 11 includes, outward from the central blowing hole 111 in order; inner protrusions 110, a slit blowing hole 112, and outer protrusions 110. Also through the slit blowing hole 112, air is blown and infrared rays are radiated.

Each of the protrusions 110 are disposed in a ring shape, and the tops of the protrusions 110 respectively incline towards the center of the ring. Thus, the tops can equally come into contact with the scalp along the curve thereof.

Each of the protrusions 110 is made of rubber or resin, having flexibility. The protrusions 110 may have higher flexibility to provide a softer feel, or may have lower flexibility to apply more power for massaging.

The scalp massage attachment 11 has on the right and left sides thereof pinching parts 113 each of which protrudes forward and has a convex part 114 on the back of pinching parts 113. For use of the scalp massage attachment 11, the convex part 114 is inserted to fit with a concave part 131a formed on a guard surface 131 of the vibrator 13 so that the scalp massage attachment 11 is attached. In nonuse, the pinching parts 113 may be pulled forward so as to detach the scalp massage attachment 11.

At the portion to which the scalp massage attachment 11 is attached, the blower port case 12 is shaped. The blower port case 12 is a substantially-cylindrical member 120, including inside a flow passage of the air from the blower fan 16.

On each of the top surface and the bottom surface of the blower port case 12, three exhaust holes 121 are arranged. The exhaust holes 121 are located near the base part of the protrusions 110 of the scalp massage attachment 11, which allows the exhaust holes 121 to exhaust excess air so as to adjust the air volume blown through the central blowing hole 111 when the scalp massage attachment 11 is attached.

Air can escape from the blower port of the blower port case 12 without any resistance when the scalp massage attachment 11 is detached. Thus, the exhaust holes 121 function so that an appropriate blowing volume is ensured respectively in either case when the scalp massage attachment 11 is attached or detached.

The blower port case 12 has on each of the right and left sides of the end edge thereof an appropriate retreat part 122 to which the finger is inserted to pinch the pinching part 113 to detach the scalp massage attachment 11. The formation gives a design effect in appearance, as well as improving detachability.

The blower port case 12 has along the air flow passage, that is, in the full length of the blower port case 12, in order; the scalp massage attachment 11, the guard surface 131 of the vibrator 13, the ceramic heater 14 and the nichrome wire heater 15 as its interior.

The vibrator 13 including as a vibrator a vibration motor 130 that is a known weight motor transmits the vibration generated by the vibration motor 130 to the guard surface 131, and further vibrates the scalp massage attachment 11 attached to the guard surface 131.

The guard surface 131 prevents the fingers from touching the ceramic heater 14, the nichrome wire heater 15, and the like.

The vibrator 13 is connected to the blower port case 12 with a flexible metal fitting 132 having flexibility at the back end. The configuration hardly transmits the vibration from the vibration motor 130 to the ceramic heater 14, the nichrome wire heater 15 and the like. Therefore, even while the vibrator is in operation, uncomfortable vibration is hardly transmitted to the dryer body 1 and the handle part 20.

As one of the features of the invention, the nichrome wire heater 15 that is generally included in a conventional dryer, and also the ceramic heater 14 for radiating infrared rays are arranged respectively. The ceramic heater 14 is located just behind the scalp massage attachment 11, and thus the generated infrared rays go through the central blowing hole 111 of the scalp massage attachment 11 and others, efficiently acting on the scalp.

The back end of the blower port case 12 is connected to the housing 3 integrally formed with the handle part 20. The upper part of the housing 3 has a cylindrical shape, and the blower fan 16 is arranged inside. A fan 161 rotated by the motor 160 of the blower fan 16 sucks air from the air supply port 18 through the filter 17, and blows the air towards the blower port case 12.

Therefore, the air blown by the blower fan 16 is heated by one or the both of the nichrome wire heater 15 and the ceramic heater 14, and then supplied through the blower port. The arrangement in this order exerts a special effect according to the invention.

That is, a ceramic part of the ceramic heater 14 is heated by the hot air heated by the nichrome wire heater 15 when the nichrome wire heater 15 is on, and thus, infrared rays can be radiated regardless of the ceramic heater 14 being on or off.

In the invention, a low output ceramic heater having output power of 400 W or less is desirably used. Using a low output heater allows the arrangement of the heater near the blower port as described in the example, and the arrangement can give a thermal effect directly to the scalp and hair.

Especially, used is a ceramic heater having output power of 150 W or less, further in the example, a low output heater of 100 W is used.

As for the nichrome wire heater, a heater of 1200 W or less is used, especially in the example, a heater of 800 W. A general dryer includes a nichrome wire heater having output power of approximately 700 W to 1500 W. However, the dryer of the invention additionally with the use of a ceramic heater so as to utilize a thermal effect by infrared rays can exert a sufficient drying effect even with the output power of approximately 800 W. Moreover, controlling the two heaters as described below allows the dryer to provide various operation modes.

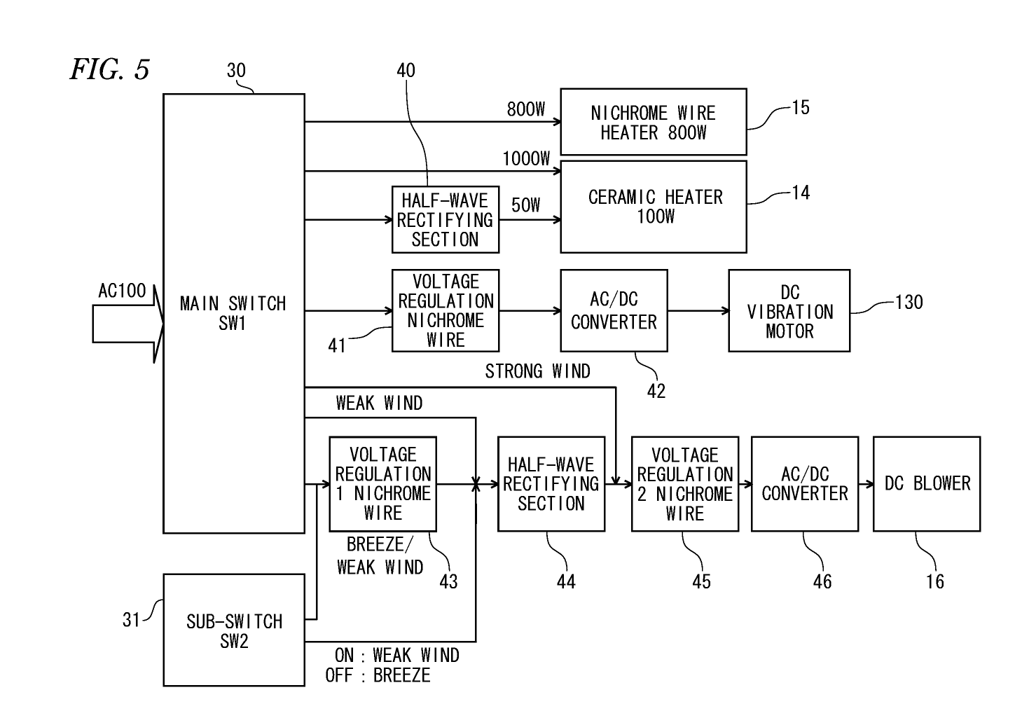

FIG. 5 shows a block diagram illustrating the control of the dryer of the invention.

The handle part 20 of the dryer body 1 has a main switch 30 and a sub-switch 31. A user operates the heaters and the fan by switching the switches.

The main switch 30 functions for switching the nichrome wire heater 15 of 800 W on or off, the ceramic heater 14 of 100 W on or off, and the operation of a half-wave rectifying section 40 of 50 W with alternating current. That is, as for the operation of the heaters in the example, the ceramic heater of 50 W or 100 W, the nichrome wire heater of 800 W, and the combination of these can be adjusted.

Further, the vibration motor 130 functioning as a vibrator is also on and off switchable. The vibration motor 130, a DC motor, is operated by a voltage regulation nichrome wire 41 and an AC/DC converter 42. As one of the features of the invention, a prescribed portion of the nichrome wire heater 15 is used to regulate voltage. This allows reduction of the number of components, and further allows the efficient use of the heat generated during the voltage regulation.

With regard to the main switch 30, the blower fan 16 is operated under two conditions. That is, when the blower fan 16 is on, the condition is switchable between a strong wind condition and a weak wind condition, in addition to on and off switching. In a weak wind condition, a half-wave rectifying section 44 is operated to halve the output power. In a strong wind condition, full waves are used. In either case, the blower fan 16 is operated by an AC/DC converter 46 and a voltage regulation nichrome wire 45 by use of a prescribed portion of the nichrome heater 15.

With regard to the sub-switch 31, depending on whether it is on or off, a voltage regulation nichrome wire 43 is operated. In the off state of the voltage regulation nichrome wire 43, the voltage is lowered, and thus the blower fan 16 can supply a breeze weaker than a weak wind.

By use of electric resistance of the nichrome wire for the nichrome wire heater, the blower and the vibration motor are controlled in the above configuration, while the ceramic heater may also be controlled.

The dryer body 1 of the invention provides the following operation modes by the above control system.

Massaging Mode

In this mode, the output power of the ceramic heater 14 is set to 50 W, and the nichrome wire heater 15 is in an off state. The air volume by the blower fan 16 is set to a breeze or a weak wind, and the scalp massage attachment 11 is vibrated by the vibrator 13.

The purpose of this mode is to perform scalp massaging by transmitting vibrations while applying a moderately warm wind with the scalp massage attachment 11 directly attached to the scalp.

Low-Temperature Hair Dry Mode

In this mode, the output power of the ceramic heater 14 is set to 100 W, and the nichrome wire heater 15 is in an off state. The air volume by the blower fan 16 is set to a weak wind. The vibrator 13 is in an off state.

The purpose of this mode is to dry hair while keeping the skin at 60 degrees or less with the blower port held away from the scalp. In this mode, a user can dry hair while protecting the scalp and hair from heat.

High Temperature Hair Dry Mode

In this mode, the output power of the ceramic heater 14 is set to 100 W, and the nichrome wire heater 15 of 800 W is in an on state. The air volume by the blower fan 16 is set to a strong wind. The vibrator 13 is in an off state.

This mode is to heat air by the two heaters and further radiate infrared rays as a normal hair dryer function. The purpose of this mode is to quickly dry hair with a sufficient air volume.

In the invention, an auxiliary handle part may be arranged on the dryer. The auxiliary handle part is arranged in the back side of the scalp massage attachment so that a user can press the scalp massage attachment towards the scalp. A user can grasp the handle part 20 with one hand while holding the auxiliary handle part with the other hand.

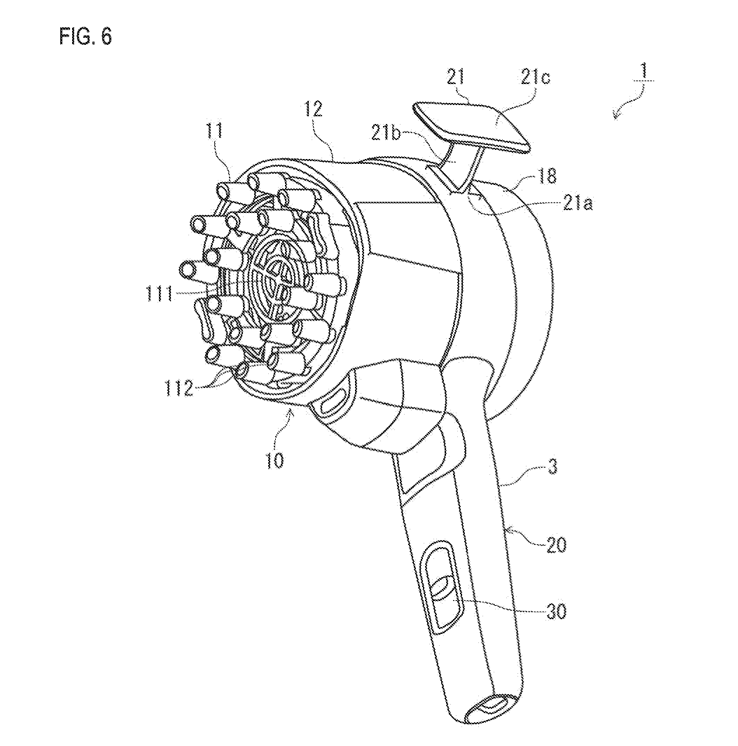

FIG. 6 shows the first example of an auxiliary handle part 21. As shown in the figure, the auxiliary handle part 21 has a base portion 21a on a side surface of the cylindrical portion of the housing 3, and a pressing face part 21b that is a wide flat plate arranged on the base portion 21a, parallel to a radial cross section of the cylindrical part 10. The pressing face part 21b facilitates pressing forward from the back surface thereof, resulting in efficient massaging.

A flat plate part 21c is extended in front and back directions based on the end of the pressing face part 21b opposite to the base portion 21a. That is, the auxiliary handle part 21 has a T-shaped member integrally including the pressing face part 21b and the plate part 21c.

In an example, a user can press the scalp massage attachment to the scalp by pinching the front and back faces of the pressing face part 21b with fingers and grasping the plate part 21c with the palm. Alternatively, a user may sandwich the front and back faces of the pressing face part 21b with fingers, and cover the cylindrical portion of the housing 3 with the palm. In this case, the plate part 21c functions to prevent fingers from being removed.

The auxiliary handle part 21 is desirably arranged so that a user can hold the auxiliary handle part 21 in a different direction than the handle part 20. Thus, the auxiliary handle part 21 is desirably arranged in a right or left side on the cylindrical surface of the cylindrical part 10, especially upper part of the cylindrical part 10, that is, at 90 degrees or more with respect to the handle part 20. In the first example, according to the assumption in which a right-handed user grasps the handle part 20 with the left hand and the auxiliary handle part 21 with the right hand, the auxiliary handle part 21 is arranged in the left side based on the front view at a position of approximately 120 degrees with respect to the handle part 20.

In the first example, the auxiliary handle part 21 has one of the optimum shapes that can perform efficient massaging by the dryer including the scalp massage attachment as described above. However, in the invention, other aspects may be provided, not limited to the above example. In another example, a part corresponding to the pressing face part may be shaped longer than the pressing face part shown in the figure so that a user can grasp the part with the palm. In this case, the part may be formed in a bar shape to be easily grasped, not in a plate shape. A plate part 21c may be extended only in one of the front and back directions, not limited to the configuration extended in both directions.

An auxiliary handle part 21 may be arranged upward in one of the left and right sides, or in both sides.

In the first example, the auxiliary handle part 21 is fixed, but may be detachable. In another example, an auxiliary handle part may be designed so that only when using a scalp massage attachment, a base portion of the auxiliary handle part is inserted into a hole part that is opened on the side surface of a cylindrical part 10.

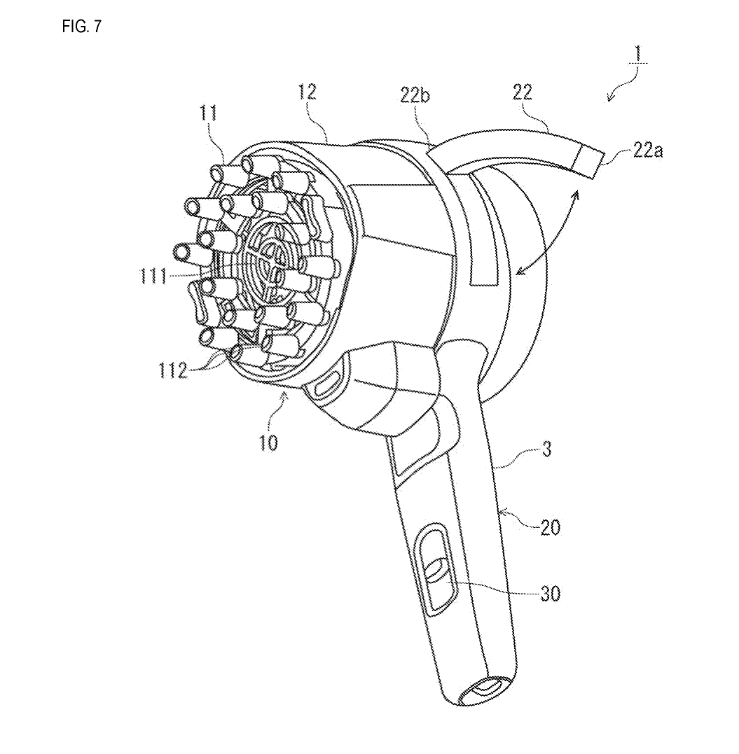

FIG. 7 shows the second example of an auxiliary handle part. In the example, an auxiliary handle part 22 is formed to be foldable. The auxiliary handle part 22 is stored integrally in an outside periphery of a cylindrical part 10 for storage, when in use a grasping part 22a is opened with a hinge part 22b as a fulcrum.

Given such a storable configuration the auxiliary handle part 22 does not obstruct storage and usage, which further improves usability.

In the invention, a vibration attachment for mounting to a dryer may be provided as a single unit. That is, an attachment is configured to include a mounting part for mounting to a blower port of the dryer, a scalp massage attachment attached along a blowing direction of the blower port, and a vibrator for generating vibration to vibrate the scalp massage attachment.

That is, the attachment includes at least the scalp massage attachment 11 and the vibrator 13 of the above example, and is configured to be detachable from a general dryer. In an example, the attachment may be configured to fit an outer circumference of a blower port so as to be mountable to a dryer. Alternatively, an engaging part and a seizing part may be formed respectively.

The attachment may include a cylindrical case that corresponds to the end part of the blower port case 12 of the above example, and is formed in a similar shape to a nozzle part of a normal known dryer so as to be replaceable with a nozzle.

According to the invention, a dryer with the configuration described above can provide a various operation modes including a massaging function by a vibrator, a thermal function by infrared rays, and these combinations.

The dryer can sufficiently dry hair on the scalp by the infrared rays radiated from the dryer, and also comfortably dry hair without a brush part becoming excessively hot. Moreover, the dryer according to the invention with a vibration function by a scalp massage attachment can synergistically exert a thermal effect by infrared rays and a massaging effect by vibration.

### REFERENCE SIGNS LIST

1: dryer body
10: cylindrical part
11: scalp massage attachment
110: protrusion
111: central blowing hole
112: slit blowing hole
113: pinching part
114: convex part
12: blower port case
120: substantially-cylindrical member
121: exhaust hole
122: retreat part
13: vibrator
130: vibration motor
131: guard surface
131a: concave part
132: metal fitting
14: ceramic heater
140: heater surface
15: nichrome wire heater
16: blower fan
160: motor
161: fan
17: filter
18: air supply port case
20: handle part
21: auxiliary handle part
3: housing
30: main switch
31: sub-switch

1. A dryer that performs drying and a vibratory stimulation to a scalp, the dryer comprising in a dryer body:
a blower that sucks air from outside and blows the air towards a blower port;
a heater that heats the blown air;
a scalp massage attachment that is attached along a blowing direction of the blower port; and
a vibrator that generates vibration to vibrate the scalp massage attachment.

2. The dryer according to claim 1, the dryer comprising:
at least an infrared ray heater as the heater of the dryer body to radiate infrared rays to the scalp and hair through the blower port.

3. The dryer according to claim 1, wherein
an auxiliary handle part for pressing the scalp massage attachment towards the scalp is attached in a back side of the scalp massage attachment of the dryer body.

4. The dryer according to claim 2, the dryer comprising:
as the heater of the dryer body, a ceramic heater that has output power of 400 W or less to mainly radiate infrared rays; and
a nichrome wire heater that has output power of 1200 W or less to mainly heat air, wherein
the ceramic heater is only used so as to perform the vibratory stimulation by the scalp massage attachment,
while at least one of the ceramic heater and the nichrome wire heater is used so as to perform the drying.

5. The dryer according to claim 4, wherein
the dryer body includes a cylindrical part and a handle part that is extended downward from a cylindrical side face of the cylindrical part,
having in the cylindrical part from an edge part in order the scalp massage attachment, the blower port, the ceramic heater, the nichrome wire heater and the blower,
further having a vibration transmission part that uses a vibration motor as the vibrator and connects the scalp massage attachment and the vibration motor, and
a user uses the dryer with the blower port facing a body by grasping the handle part.

6. The dryer according to claim 5, wherein
the auxiliary handle part is extended from the cylindrical side face of the cylindrical part at least one of in a left side, in a right side and on an upper part, and
the auxiliary handle part has a pressing face part parallel to a radial cross section of the cylindrical part.

7. The dryer according to claim 4, wherein
by use of an electric resistance of a nichrome wire used for the nichrome wire heater, at least one of the blower and the ceramic heater is controlled.

8. The dryer according to claim 1, wherein
the scalp massage attachment is detachable in a vicinity of the blower port.

9. A vibration attachment that is mounted to a dryer body, the vibration attachment for dryer comprising:
a mounting part that is mounted to a blower port of the dryer body;
a scalp massage attachment that is attached along a blowing direction of the blower port; and
a vibrator that generates vibration to vibrate the scalp massage attachment.
